(19) United States
(12) Patent Application Publication
(10) Pub. No.: US 2026/0077348 A1
(43) Pub. Date: Mar. 19, 2026

(54) PACKAGE STRUCTURE

(71) Applicant: TONG HSING ELECTRONIC INDUSTRIES, LTD., Taoyuan City (TW)

(72) Inventors: TIEN-HAO CHENG, Taoyuan City (TW); Cheng-Chang Wu, Taoyuan City (TW); LI-CHUN HUNG, Taoyuan City (TW)

(21) Appl. No.: 18/971,210

(22) Filed: Dec. 6, 2024

(30) Foreign Application Priority Data
Sep. 13, 2024 (TW) 113134754

(51) Int. Cl. B01L 3/00

(52) U.S. Cl. CPC B01L 3/502715; B01L 2300/0816; B01L 2300/0887

(57) ABSTRACT

A package structure includes a substrate having a processing surface, one or more microfluidic structures disposed on the processing surface, and a bonding adhesive. Each microfluidic structure includes at least one flow channel, and the at least one flow channel extends from a central portion of the processing surface toward at least one of a plurality of corners of the processing surface. The one or more microfluidic structures are configured to guide the bonding adhesive to contact the one or more microfluidic structures and to flow along the at least one flow channel from an inner position of the processing surface in a plurality of outward directions with respect to the processing surface through guidance of the at least one flow channel. A distribution region of the bonding adhesive after flowing is defined as a bonding region.

### CROSS-REFERENCE TO RELATED PATENT APPLICATION

This application claims the benefit of priority to Taiwan Patent Application No. 113134754, filed on Sep. 13, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a package structure, and more particularly to a semiconductor package structure.

### BACKGROUND OF THE DISCLOSURE

With the advancement of semiconductor technologies, chip packaging or an electronic device is developed to have high sophistication. For example, in the conventional technology, the above-mentioned electronic device can be a power semiconductor, a microprocessor, and a communication device. In such an electronic device, a semiconductor die is to be packaged on a substrate. The packaging technology can be, for example, interstitial ball grid array (iBGA) packaging, in which a die is bonded to the substrate via a bonding adhesive (e.g., an epoxy resin).

However, an issue of adhesive overflow may occur when the bonding adhesive is used in an excessive amount, and the bonding adhesive extends to a conductive layer that is next to the die, thereby causing wiring abnormality. A gap is generated below a corner of the die when the bonding adhesive is not used in a sufficient amount, and an encapsulant may seep into the gap, thereby generating a crack in a package structure.

Therefore, how to manufacture one package structure that overcomes the above-mentioned problems has become one of the important issues to be solved in the relevant industry.

### SUMMARY OF THE DISCLOSURE

In response to the above-referenced technical inadequacies, the present disclosure provides a package structure, so as to effectively improve the problem of using an excessive or insufficient amount of a bonding adhesive, reduce the problem of generating a crack in a package structure and contaminating a conductive layer by the bonding adhesive, and enhance the quality of the package structure.

In order to solve the above-mentioned problems, one of the technical aspects adopted by the present disclosure is to provide a package structure, which includes a substrate, one or more microfluidic structures, and a bonding adhesive. The substrate has a processing surface. The one or more microfluidic structures are disposed on the processing surface. Each of the one or more microfluidic structures includes at least one flow channel, and the at least one flow channel extends from a central portion of the processing surface toward at least one of a plurality of corners of the processing surface. The one or more microfluidic structures are configured to guide the bonding adhesive to contact the one or more microfluidic structures and to flow along the at least one flow channel from an inner position of the processing surface in a plurality of outward directions with respect to the processing surface through guidance of the at least one flow channel. A distribution region of the bonding adhesive after flowing is defined as a bonding region.

In one of the possible or preferred embodiments, the package structure further includes a die. The die has a bonding surface, and is adhered to the substrate via the bonding adhesive. The bonding region is greater than or equal to an area of the bonding surface.

In one of the possible or preferred embodiments, the package structure further includes a barrier. The barrier surrounds the one or more microfluidic structures, and is configured to block the bonding adhesive from overflowing therefrom in a lateral direction.

In one of the possible or preferred embodiments, the package structure further includes a plurality of conductive layers. The conductive layers are disposed on the processing surface, and are each disposed at an outer side of the barrier.

In one of the possible or preferred embodiments, a quantity of the one or more microfluidic structures is two, and the two microfluidic structures are arranged to be mirror-symmetrical with respect to a center line of the processing surface.

In one of the possible or preferred embodiments, each of the microfluidic structures has a first guide section, a second guide section, and a third guide section that are continuously connected. The second guide section is parallel to the center line, and the first guide section and the third guide section extend in the outward directions with respect to the processing surface.

In one of the possible or preferred embodiments, a quantity of the one or more microfluidic structures is two, a center point of the processing surface is configured as an intersection point at which the two microfluidic structures intersect, and two ends of each of the microfluidic structures respectively face toward two opposite ones of the corners of the processing surface.

In one of the possible or preferred embodiments, a quantity of the one or more microfluidic structures is plural, and the multiple microfluidic structures intersect at a center point of the processing surface and are arranged to be point-symmetrical with respect to the center point.

Therefore, in the package structure provided by the present disclosure, by virtue of “one or more microfluidic structures being disposed on the processing surface, each of the one or more microfluidic structures including at least one flow channel, and the at least one flow channel extending from a central portion of the processing surface toward at least one of a plurality of corners of the processing surface,” “the one or more microfluidic structures being configured to guide a bonding adhesive, and the bonding adhesive contacting the one or more microfluidic structures from an inner position of the processing surface and flowing in the at least one flow channel,” and “from the inner position, the bonding adhesive flowing in a plurality of outward directions with respect to the processing surface through guidance of the at least one flow channel”, the bonding adhesive is evenly distributed on the substrate, thereby enabling a chip to be bonded to the substrate.

According to certain embodiments, the bonding region is greater than or equal to the bonding surface of the die, so as to prevent a gap from being formed below a corner of the die. In this way, an encapsulant is unable to seep into the gap, and the problem of crack generation in the package device can be reduced.

Furthermore, according to one embodiment, the package structure further includes the barrier. The barrier surrounds the microfluidic structure, and blocks the bonding adhesive from overflowing therefrom in the lateral direction. Hence, the bonding adhesive can be prevented from overflowing and contaminating the conductive layer or an electronic component on the substrate, such that the quality of the package device is enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a package structure according to one embodiment of the present disclosure;

FIG. 2 is a schematic top view of a substrate and microfluidic structures of the package structure according to one embodiment of the present disclosure;

FIG. 3 and FIG. 4 are each a schematic view showing flowing of a bonding adhesive of the package structure in the embodiment of FIG. 2;

FIG. 5 is a schematic top view of the substrate and the microfluidic structures according to one embodiment of the present disclosure; and

FIG. 6 and FIG. 7 are each a schematic view showing flowing of the bonding adhesive in the embodiment of FIG. 5.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

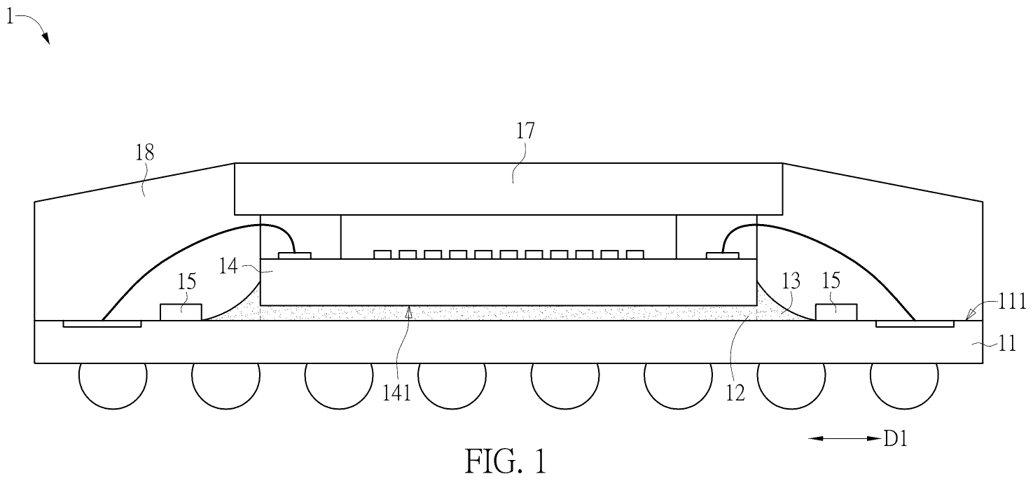

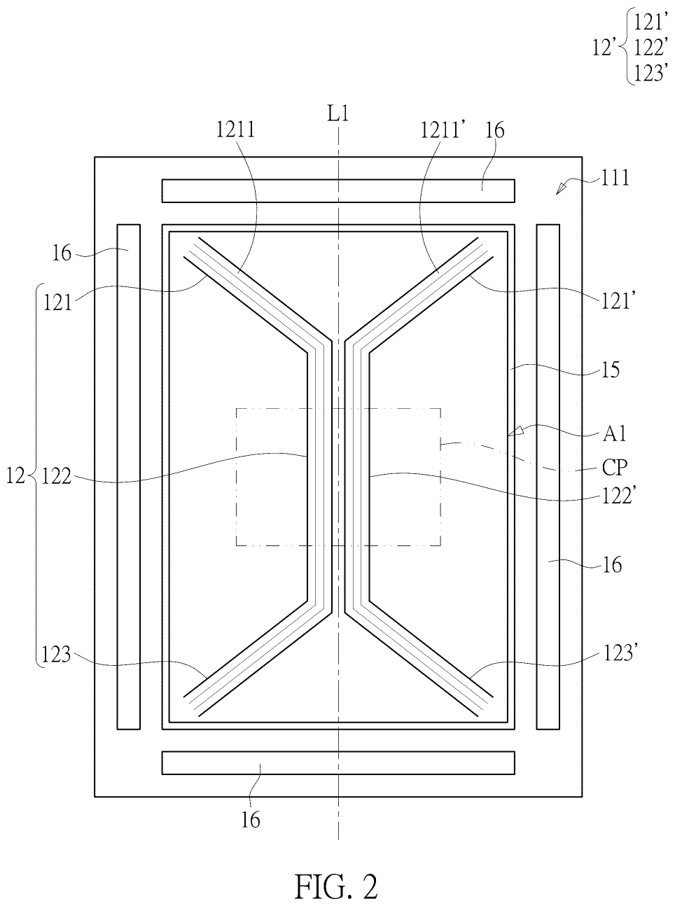

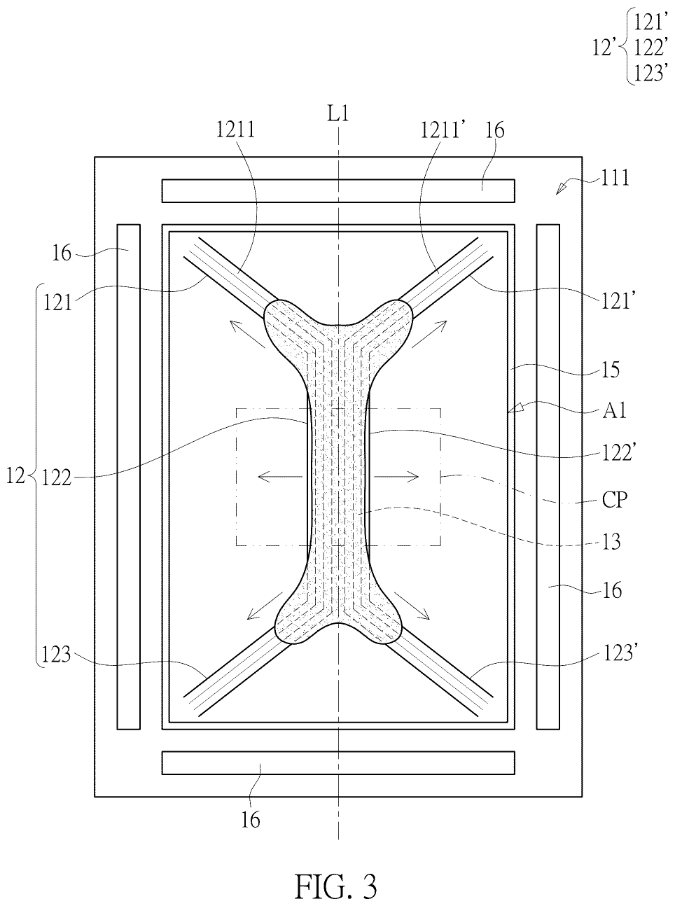

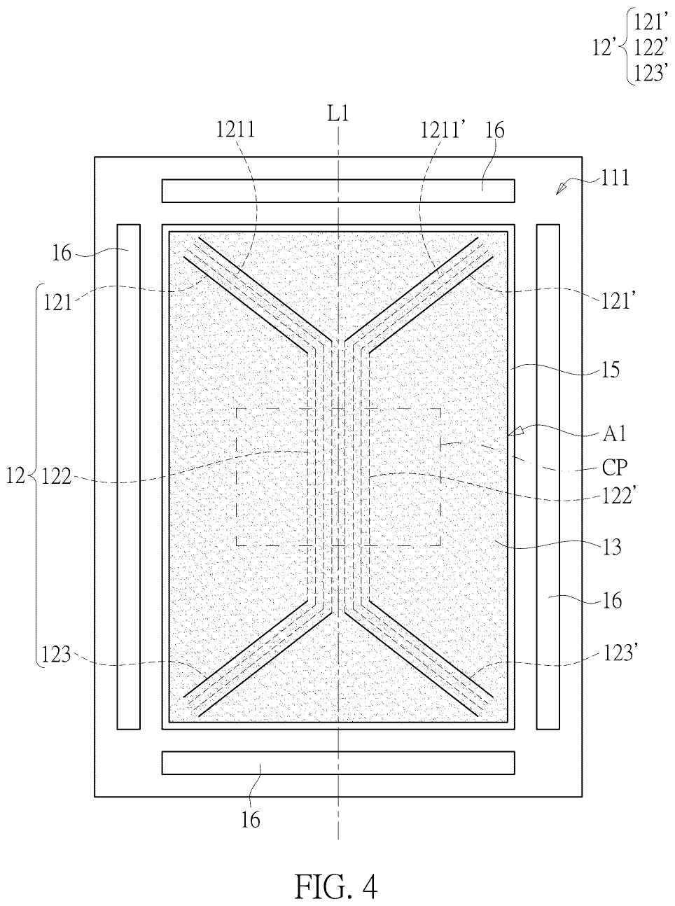

Referring to FIG. 1 to FIG. 4, FIG. 1 is a schematic view of a package structure according to one embodiment of the present disclosure, FIG. 2 is a schematic top view of a substrate and microfluidic structures of the package structure according to one embodiment of the present disclosure, and FIG. 3 and FIG. 4 are each a schematic view showing flowing of a bonding adhesive of the package structure in the embodiment of FIG. 2.

As shown in the embodiment of FIG. 1, a package structure 1 includes a substrate 11, a die 14, one or more microfluidic structures 12, a bonding adhesive 13, a light-permeable member 17, and an encapsulant 18. The substrate 11 has a processing surface 111, and the one or more microfluidic structures 12 are disposed (or formed) on the processing surface 111. Each microfluidic structure 12 includes at least one flow channel 1211. According to certain embodiments, the at least one flow channel 1211 is formed (or defined) by a plurality of partitions. As shown in FIG. 2, the at least one flow channel 1211 extends from a central portion CP of the processing surface 111 toward at least one of corners of the processing surface 111. The one or more microfluidic structures 12 are configured to guide the bonding adhesive 13 to flow along the at least one flow channel 1211. Specifically, the bonding adhesive 13 contacts the one or more microfluidic structures 12 and flows along the at least one flow channel 1211 from an inner position of the processing surface 111 in a plurality of outward directions with respect to the processing surface 111 through guidance of the at least one flow channel 1211. Accordingly, a distribution region of the bonding adhesive 13 after flowing is defined as a bonding region A1. According to certain embodiments, the bonding adhesive 13 flows toward the corners of the processing surface 111 from the inner position of the processing surface 111 (as shown in FIG. 3). The die 14 has a bonding surface 141, and is adhered to the substrate 11 via the bonding adhesive 13. According to certain embodiments, an area of the bonding region A1 is greater than or equal to an area of the bonding surface 141 of the die 14.

The substrate 11 can be, for example, a printed circuit board. According to certain embodiments, the partitions of the microfluidic structure 12 are formed by a solder mask technique and material deposition, and one flow channel 1211 is formed by two of the partitions. In other words, each microfluidic structure 12 can include the at least one flow channel 1211 that extends from the central portion CP of the processing surface 111 toward at least one the corners of the processing surface 111. As shown in FIG. 2, the package structure 1 of the present embodiment includes two microfluidic structures (12, 12′). The quantity of the at least one flow channel 1211 in the microfluidic structure 12 is three (and the microfluidic structure 12′ includes three flow channels 1211′). As shown in FIG. 3 and FIG. 4, a manufacturer places the bonding adhesive 13 on the processing surface 111 for contacting the microfluidic structure 12. From the inner position of the processing surface 111, the bonding adhesive 13 flows in the outward directions with respect to the processing surface 111. The bonding region A1 is formed by a distribution range of the flowing bonding adhesive 13, and the die 14 is further adhered within the bonding region A1. In this way, no gap exists between a lower portion of the die 14 and the processing surface 111, and the lower portion of the die 14 is completely bonded to the substrate 11 via the bonding adhesive 13. In certain embodiments, the bonding adhesive 13 is placed on the microfluidic structures 12, 12′ in substantially a double-Y shape (e.g., one Y shape of the bonding adhesive 13 is arranged on the upper portion of the double-Y shape, and the other Y shape of the bonding adhesive 13 is disposed upside down and arranged on the lower portion of the double-Y shape) by the manufacturer, but the present disclosure is not limited thereto.

In the embodiment shown in FIG. 2, the package structure 1 further includes a barrier 15. The barrier 15 has a rectangular ring-shape and surrounds the microfluidic structure 12, and corners of the barrier 15 respectively correspond in position to the corners of the processing surface 111, but the present disclosure is not limited thereto. Specifically, the barrier 15 is configured to block the bonding adhesive 13 from overflowing therefrom in a lateral direction D1. In other words, a range of the bonding region A1 can be limited by the barrier 15, so as to prevent the bonding adhesive 13 from overflowing out of the bonding region A1. According to certain embodiments, conductive layers 16 (e.g., gold fingers) are further disposed on the processing surface 111 of the substrate 11, and are each disposed at an outer side of the barrier 15. Since the barrier 15 can block the bonding adhesive 13 from overflowing therefrom in the lateral direction D1, the bonding adhesive 13 will not overflow and contact (contaminate) the conductive layers 16. The barrier 15 can also be formed by the solder mask technique and material deposition mentioned previously (in the same manner as the microfluidic structure 12). However, the present disclosure is not limited thereto.

According to certain embodiments, there are two microfluidic structures (i.e., the microfluidic structures 12, 12′), and the two microfluidic structures 12, 12′ are arranged to be mirror-symmetrical with respect to a center line L1 of the processing surface 111. The center line L1 passes through the central portion CP along a longitudinal direction of the processing surface 111. Taking FIG. 2 as an example, there are three flow channels 1211 in the microfluidic structure 12, and there are three flow channels 1211′ in the microfluidic structure 12′. The microfluidic structure 12 has a first guide section 121, a second guide section 122, and a third guide section 123 that are continuously connected. The microfluidic structure 12′ has a first guide section 121′, a second guide section 122′, and a third guide section 123′ that are continuously connected. The second guide sections 122, 122′ are parallel to the center line L1, and the first guide sections 121, 121′ and the third guide sections 123, 123′ extend in the outward directions with respect to the processing surface 111. In the embodiment shown in FIG. 2, the first guide sections 121, 121′ and the third guide sections 123, 123′ extend toward the corners of the processing surface 111.

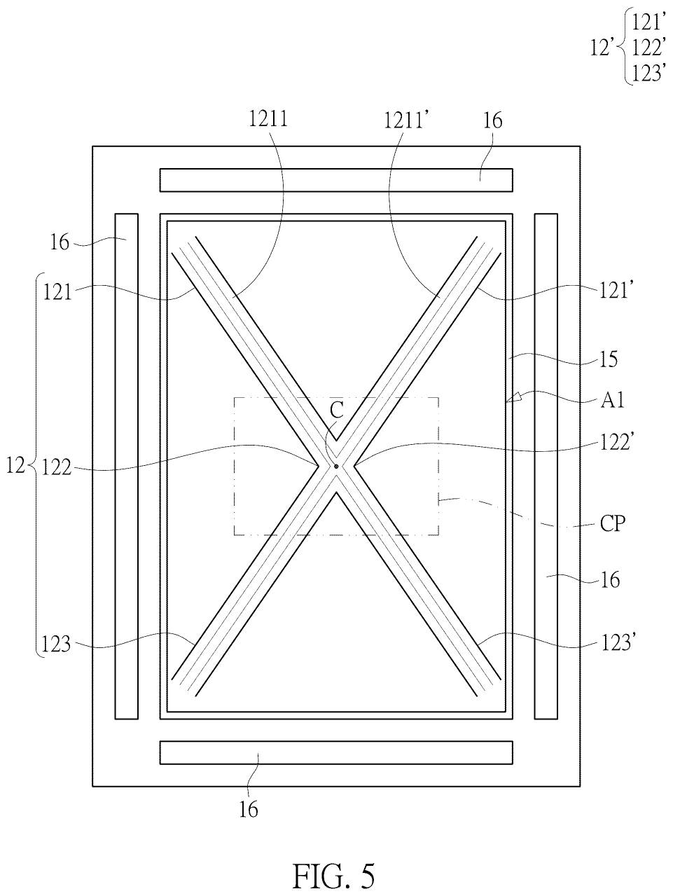

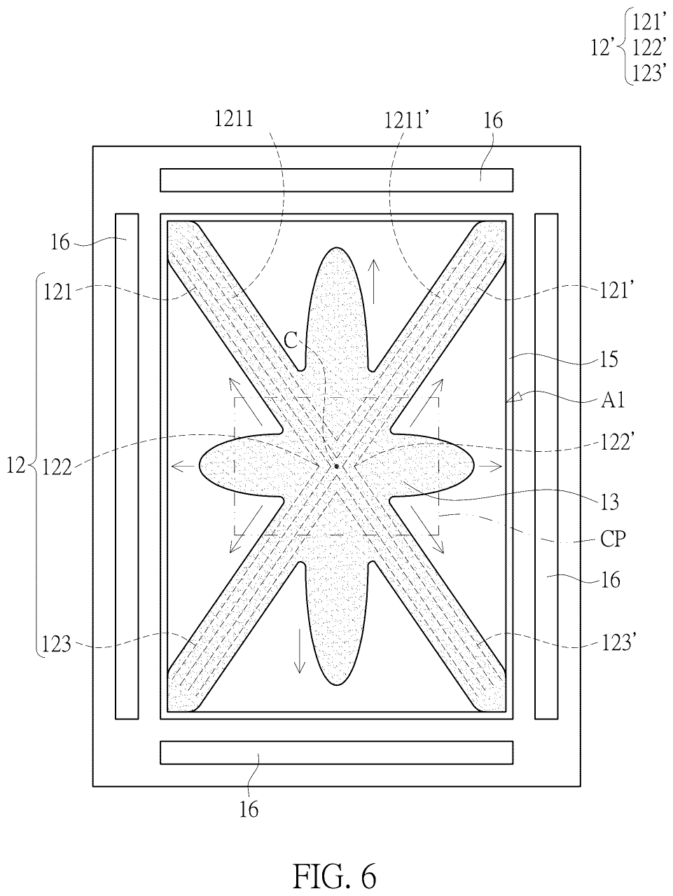

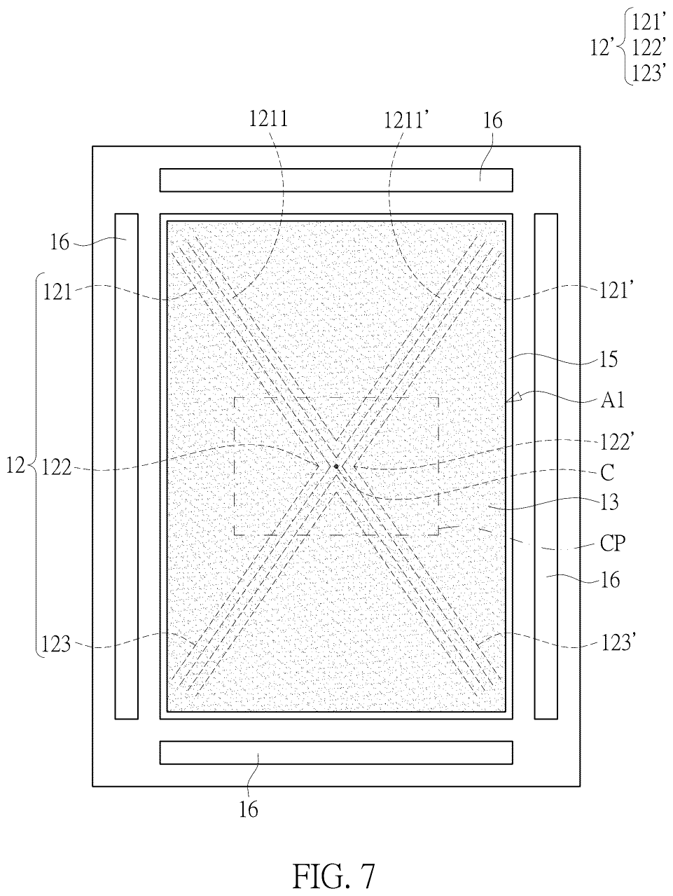

Referring to FIG. 5 to FIG. 7, FIG. 5 is a schematic top view of the substrate and the microfluidic structures according to one embodiment of the present disclosure, and FIG. 6 and FIG. 7 are each a schematic view showing flowing of the bonding adhesive in the embodiment of FIG. 5. According to the embodiment shown in FIG. 6, there are two microfluidic structures (i.e., the microfluidic structures 12, 12′). A center point C within the central portion CP of the processing surface 111 is configured as an intersection point at which the two microfluidic structures 12, 12′ intersect, and two ends of any one of the microfluidic structures 12, 12′ respectively extend toward two opposite ones of the corners of the processing surface 111. According to certain embodiments, there are multiple microfluidic structures, and these microfluidic structures intersect at the center point C of the processing surface 111 and are arranged to be point-symmetrical with respect to the center point C. As shown in FIG. 5, the two microfluidic structures 12, 12′ of the present embodiment are arranged to be point-symmetrical with respect to the center point C of the processing surface 111.

In certain embodiments, the bonding adhesive 13 is arranged by the manufacturer to have a Union Jack shape or asterisk shape, and the bonding adhesive 13 is eventually formed on the bonding region A1 shown in FIG. 6 and FIG. 7. However, how the manufacturer arranges the bonding adhesive 13 on the processing surface 111 is not limited in the present embodiment.

In addition, the light-permeable member 17 can be a flat glass board and bonded to the die 14 through a ring-shaped dam (not labeled in the drawings) so as to jointly to define an enclosed space that accommodates a sensing region of the die 14 therein. Moreover, the die 14 is electrically coupled to the substrate 11 through metal wires (not labeled in the drawings), and the encapsulant 18 is formed on the substrate 1. In the present embodiment, the one or more microfluidic structures 12, the bonding adhesive 13, the die 14, the barrier 15, the light-permeable member 17, the ring-shaped dam, and the wires are embedded in the encapsulant 18, but at least part of an outer surface of the light-permeable member 17 is exposed from the encapsulant 18.

### Beneficial Effects of the Embodiments

In conclusion, in the package structure provided by the present disclosure, by virtue of “one or more microfluidic structures being disposed on the processing surface, each of the one or more microfluidic structures including at least one flow channel, and the at least one flow channel extending from a central portion of the processing surface toward at least one of a plurality of corners of the processing surface,” “the one or more microfluidic structures being configured to guide a bonding adhesive, and the bonding adhesive contacting the one or more microfluidic structures from an inner position of the processing surface and flowing in the at least one flow channel,” and “from the inner position, the bonding adhesive flowing in a plurality of outward directions with respect to the processing surface through guidance of the at least one flow channel”, the bonding adhesive is evenly distributed on the substrate, thereby enabling a chip to be bonded to the substrate.

According to certain embodiments, the bonding region is greater than or equal to the bonding surface of the die, so as to prevent the gap from being formed below a corner of the die. In this way, the encapsulant is unable to seep into the gap, and the problem of crack generation in a package device can be reduced.

Furthermore, according to one embodiment, the package structure further includes the barrier. The barrier surrounds the microfluidic structure. Hence, the bonding adhesive can be prevented from overflowing and contaminating the conductive layer or an electronic component on the substrate, such that the quality of the package device is enhanced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A package structure, comprising:
a substrate having a processing surface; and
one or more microfluidic structures disposed on the processing surface, wherein each of the one or more microfluidic structures includes at least one flow channel, and the at least one flow channel extends from a central portion of the processing surface toward at least one of a plurality of corners of the processing surface;
wherein the one or more microfluidic structures are configured to guide a bonding adhesive to contact the one or more microfluidic structures and to flow along the at least one flow channel from an inner position of the processing surface in a plurality of outward directions with respect to the processing surface through guidance of the at least one flow channel; wherein a distribution region of the bonding adhesive after flowing is defined as a bonding region.

2. The package structure according to claim 1, further comprising a die, wherein the die has a bonding surface, the die is adhered to the substrate via the bonding adhesive, and an area of the bonding region is greater than or equal to an area of the bonding surface.

3. The package structure according to claim 1, further comprising a barrier, wherein the barrier surrounds the one or more microfluidic structures, and is configured to block the bonding adhesive from overflowing therefrom in a lateral direction.

4. The package structure according to claim 3, further comprising a plurality of conductive layers, wherein the plurality of conductive layers are disposed on the processing surface, and are each disposed at an outer side of the barrier.

5. The package structure according to claim 1, wherein a quantity of the one or more microfluidic structures is two, and the two microfluidic structures are arranged to be mirror-symmetrical with respect to a center line of the processing surface.

6. The package structure according to claim 5, wherein each of the microfluidic structures has a first guide section, a second guide section, and a third guide section that are continuously connected, the second guide section is parallel to the center line, and the first guide section and the third guide section extend in the plurality of outward directions with respect to the processing surface.

7. The package structure according to claim 1, wherein a quantity of the one or more microfluidic structures is two, a center point of the processing surface is configured as an intersection point at which the two microfluidic structures intersect, and two ends of each of the microfluidic structures respectively face toward two opposite ones of the plurality of corners of the processing surface.

8. The package structure according to claim 1, wherein a quantity of the one or more microfluidic structures is plural, and the multiple microfluidic structures intersect at a center point of the processing surface and are arranged to be point-symmetrical with respect to the center point.
